(19) United States
(12) Patent Application Publication
(10) Pub. No.: US 2021/0107270 A1
(43) Pub. Date: Apr. 15, 2021

(54) METHOD OF MANUFACTURING COMPOSITE MEMBER AND THE COMPOSITE MEMBER

(71) Applicant: SINTOKOGIO, LTD., Nagoya-shi (JP)

(72) Inventors: Nayuta HORIE, Toyokawa-shi (JP); Eiji YAMAGUCHI, Toyokawa-shi (JP); Yuuka ITO, Toyokawa-shi (JP)

(73) Assignee: SINTOKOGIO, LTD., Nagoya-shi (JP)

(21) Appl. No.: 17/065,087

(22) Filed: Oct. 7, 2020

(30) Foreign Application Priority Data
Oct. 10, 2019 (JP) 2019-186847

(51) Int. Cl. B32B 38/00; B32B 15/08; B32B 7/12; B32B 38/16; B32B 15/20

(52) U.S. Cl. CPC B32B 38/0012; B32B 15/08; B32B 38/0008; B32B 38/162; B32B 15/20; B32B 7/12

(57) ABSTRACT

A method of manufacturing a composite member including an aluminum member and a fiber-reinforced resin member bonded to each other, the method including: performing blasting on a surface of the aluminum member; modifying the surface of the aluminum member into aluminum hydroxide, the modifying including causing the surface of the aluminum member having undergone blasting to react with water by using at least one of heat and plasma; and directly bonding the fiber-reinforced resin member to the surface of the aluminum member modified to the aluminum hydroxide.

### CROSS-REFERENCE TO RELATED APPLICATIONS

This application is based on and claims the benefit of priority from Japanese Patent Application No. 2019-186847 filed on Oct. 10, 2019, and the entire contents of which are incorporated herein by reference.

### TECHNICAL FIELD

The present disclosure relates to a method of manufacturing a composite member and the composite member.

### BACKGROUND

WO 2017/141381 discloses a method of manufacturing a composite member. In this method, the composite member is manufactured using a base material and a resin member that are bonded to each other. On a surface of the base material, micro-order or nano-order asperities are formed. A resin member is applied into the micro-order or nano-order asperities and is cured therein, producing an enhanced anchor effect as compared with millimeter-order asperities. Thus, the composite member manufactured by this method has high bonding strength.

### SUMMARY

Aluminum is lighter and stronger than iron. Thus, aluminum is used as various components and is important as a base material of a composite member. The manufacturing method described in WO 2017/141381 is susceptible to improvement in view of improvement in the bonding strength of the composite member including the base material of aluminum.

According to an aspect of the present disclosure, a method of manufacturing a composite member is provided, the composite member including an aluminum member and a fiber-reinforced resin member that are bonded to each other. The manufacturing method includes performing blasting, modifying, and bonding. In the performing blasting, blasting is performed on the surface of the aluminum member. In the modifying, the surface of the aluminum member is modified into aluminum hydroxide. In the modifying, the surface of the aluminum member having undergone blasting is caused to react with water by using at least one of heat and plasma. In the bonding, the fiber-reinforced resin member is directly bonded to the surface of the aluminum member modified to the aluminum hydroxide.

According to the manufacturing method, blasting is performed on the surface of the aluminum member. Asperities are formed on the surface of the aluminum member having undergone blasting. The asperities contribute to an anchor effect. However, the asperities are formed by a collision of a blast material and thus have sharp projections. The sharp projections may break the fiber-reinforced resin member. According to the manufacturing method, the surface of the aluminum member having undergone blasting is modified into the aluminum hydroxide. Thus, the sharp projections are rounded. The fiber-reinforced resin member is directly bonded to the surface of the aluminum member modified to the aluminum hydroxide. The fiber-reinforced resin member is applied into the rounded asperities and is cured therein. As described above, according to the manufacturing method, sharp projections that may break the fiber-reinforced resin member can be removed by the modifying, thereby improving the bonding strength of the composite member. Moreover, on the surface of the aluminum member, an oxygen atom of a hydroxyl group in the aluminum hydroxide and a hydrogen atom contained in the resin form a hydrogen bond. Thus, a chemical bond is formed between the surface of the aluminum member and the fiber-reinforced resin member, thereby improving the bonding strength. Furthermore, the surface of the aluminum member composed of the aluminum hydroxide has pores of several tens to several hundreds nm. This can enhance the anchor effect. If an impact is applied to the composite member, the fiber-reinforced resin member is firmly bonded to the aluminum member, so that fibers in the fiber-reinforced resin member are broken before the fiber-reinforced resin member peels off from the aluminum member. This absorbs the impact on the composite member. As described above, the composite member in which the fiber-reinforced resin member is bonded has higher impact absorption than a composite member in which a resin member not containing fibers is bonded.

According to an embodiment, the aluminum hydroxide may contain at least one of diaspore, boehmite, pseudo-boehmite, bayerite, nordstrandite, gibbsite, and doyleite.

According to the embodiment, the modifying may include cleaning the surface of the aluminum member with the water. When the surface of the aluminum member is contaminated with carbon, the contamination may reduce the wettability of a fiber-reinforced resin material and interfere with a chemical bond between the surface of the aluminum member and the resin member. With this configuration, the surface of the aluminum member is cleaned with water used for modification to aluminum hydroxide, thereby suppressing a reduction in bonding strength when the bonding strength is reduced by contamination with carbon.

According to the embodiment, the modifying may include causing the surface of the aluminum member to react with water by using one of hydrothermal treatment, steam treatment, superheated steam treatment, liquid plasma, and atmospheric-pressure plasma containing water. The surface of the aluminum member can be modified by the foregoing treatment.

According to the embodiment, abrasive grains used in the performing blasting may have a particle size of 30 μm to 710 μm. Thus, an oxide film formed on the surface of the aluminum member can be properly removed. This can form a uniform aluminum hydroxide film on the surface of the aluminum member.

According to the embodiment, in the bonding step, the fiber-reinforced resin member may be directly bonded to the surface of the aluminum member by press forming or ultrasonic bonding. Thus, the fiber-reinforced resin member can be easily bonded to the surface of the aluminum member.

According to another embodiment of the present disclosure, a composite member is provided. The composite member includes: an aluminum member having asperities on the surface of the aluminum member and an aluminum hydroxide film formed on the surface of the aluminum member, and a fiber-reinforced resin member in direct contact with the surface of the aluminum member on which the aluminum hydroxide film is formed.

The composite member has the asperities on the surface of the aluminum member that is in direct contact with the fiber-reinforced resin member, thereby producing the anchor effect. Furthermore, the aluminum hydroxide film is formed on the surface of the aluminum member. An oxygen atom of the hydroxyl group of the aluminum hydroxide film and a hydrogen atom contained in resin form a hydrogen bond. Thus, a chemical bond is formed between the surface of the aluminum member and the fiber-reinforced resin member, thereby improving the bonding strength. Furthermore, the surface of the aluminum member on which the aluminum hydroxide film is formed has pores of several tens to several hundreds nm. This can enhance the anchor effect. If an impact is applied to the composite member, the fiber-reinforced resin member is firmly bonded to the aluminum member, so that fibers in the fiber-reinforced resin member are broken before the fiber-reinforced resin member peels off from the aluminum member. This absorbs the impact on the composite member. As described above, the composite member in which the fiber-reinforced resin member is bonded has higher impact absorption than a composite member in which a resin member not containing fibers is bonded.

According to the embodiment, an aluminum hydroxide film may contain at least one of diaspore, boehmite, pseudo-boehmite, bayerite, nordstrandite, gibbsite, and doyleite.

According to an aspect and an embodiment of the present disclosure, a method of manufacturing a composite member having high bonding strength and a composite member having high bonding strength are provided.

### BRIEF DESCRIPTION OF THE DRAWINGS

FIG. 1 is a perspective view illustrating a composite member according to an embodiment;

FIG. 2 is a cross-sectional view of the composite member taken along line II-II of FIG. 1;

FIG. 3 is a conceptual diagram illustrating a blasting machine used for a method of manufacturing the composite member according to the embodiment;

FIG. 4 is an explanatory drawing illustrating the configuration of the blasting machine used for the method of manufacturing the composite member according to the embodiment;

FIG. 5 is a cross-sectional view of the blast nozzle illustrated in

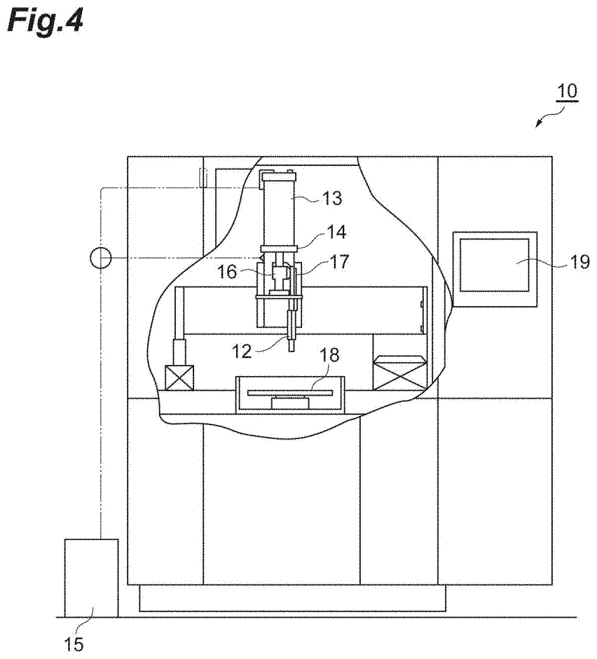

FIG. 4;

FIG. 6 is a top view of a mold used for press forming;

FIG. 7 is a cross-sectional view of the mold taken along line VII-VII of FIG. 6;

FIG. 8 is a flowchart of the method of manufacturing the composite member according to the embodiment;

FIG. 9 is a conceptual diagram of blasting;

FIG. 10 is an explanatory drawing of a scan of blasting;

FIGS. 11A-11C are explanatory drawings of the manufacturing process of the composite member;

FIGS. 12A-12F indicate the surface observation results of the aluminum member; and

FIG. 13 indicates the analysis results of the surface compositions of aluminum members.

### DETAILED DESCRIPTION

An embodiment will be described below with reference to the accompanying drawings. In the following explanation, the same or equivalent elements are indicated by the same reference numerals and a duplicate explanation thereof is omitted. Moreover, “bonding strength” in the present embodiment will be described as “shearing strength”.

[Composite Member]

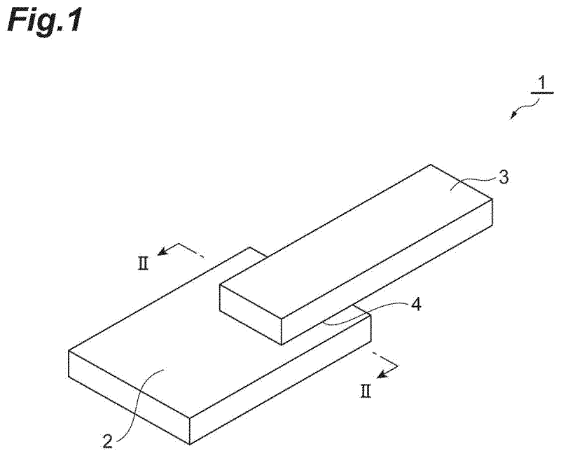

FIG. 1 is a perspective view illustrating a composite member 1 according to the embodiment. As illustrated in FIG. 1, the composite member 1 is a member including a plurality of members integrated by bonding. For example, the composite member 1 is a member including a fiber-reinforced resin member and a foreign member of the fiber-reinforced resin member, the fiber-reinforced resin and foreign members being bonded to each other. The foreign member of the fiber-reinforced resin member is a member made of materials having different characteristics from the materials of the fiber-reinforced resin member, such as a coefficient of thermal expansion, a coefficient of heat transfer, and strength. The composite member 1 has impact absorption as will be described later.

The composite member 1 includes an aluminum member 2 and a fiber-reinforced resin member 3. The aluminum member 2 is, for example, a plate member. The fiber-reinforced resin member 3 is in direct contact with a surface of the aluminum member 2. In FIG. 1, the fiber-reinforced resin member 3 is in direct contact with a part of the surface of the aluminum member 2 (a contact surface 4 of the aluminum member 2) and has a lap joint structure. The material of the aluminum member 2 is aluminum or an aluminum alloy.

The material of the fiber-reinforced resin member 3 is thermoplastic fiber-reinforced resin or thermosetting fiber-reinforced resin. The thermoplastic fiber-reinforced resin includes, for example, aromatic polyamide fiber reinforced thermo plastics (AFRTP), carbon fiber reinforced thermo plastics (CFRTP), and glass fiber reinforced thermo plastics (GFRTP). The thermosetting fiber-reinforced resin includes, for example, aromatic polyamide fiber reinforced plastics (AFRP), carbon fiber reinforced plastics (CFRP), and glass fiber reinforced plastics (GFRP).

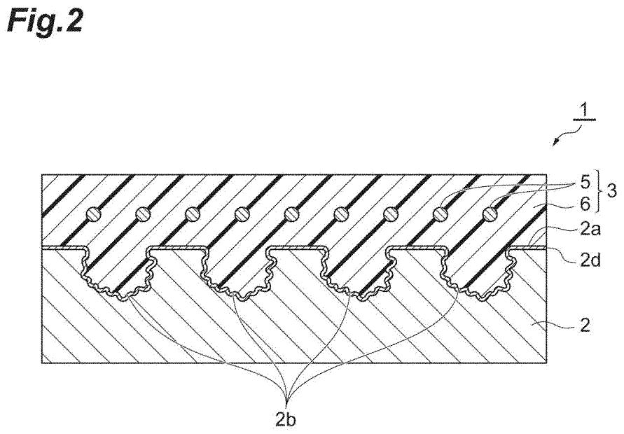

FIG. 2 is a cross-sectional view of the composite member 1 taken along line II-II of FIG. 1. As illustrated in FIG. 2, the aluminum member 2 has asperities 2b on a part (contact surface 4) of the surface 2a. The asperities 2b are micro-order or nano-order asperities. The micro-order asperities are asperities having a height difference of 1 μm to less than 1000 μm. The nano-order asperities are asperities having a height difference of 1 nm to less than 1000 nm. The ends of the asperities 2b are chamfered. Thus, the asperities 2b are rounded and have no acute-angled points. The fiber-reinforced resin member 3 is fixed into the asperities 2b and thus produces an anchor effect.

Furthermore, an aluminum hydroxide film 2d is formed on the surface of the aluminum member 2. The aluminum hydroxide film 2d is a film made of aluminum hydroxide and has pores of several tens to several hundreds nm on the surface. The aluminum hydroxide is an aluminum compound having a hydroxyl group. The aluminum hydroxide film 2d contains at least one of diaspore, boehmite, pseudo-boehmite, bayerite, nordstrandite, gibbsite, and doyleite. The aluminum hydroxide film 2d may contain any one of diaspore, boehmite, pseudo-boehmite, bayerite, nordstrandite, gibbsite, and doyleite. The aluminum hydroxide film 2d may contain multiple kinds of aluminum hydroxides selected from the group consisting of diaspore, boehmite, pseudo-boehmite, bayerite, nordstrandite, gibbsite, and doyleite.

The fiber-reinforced resin member 3 partially applied into the asperities 2b is bonded to the aluminum member 2. Such a structure is formed by press forming using a mold 20, which will be described later. The composite member 1 may be bonded using techniques other than press forming, for example, ultrasonic bonding, injection molding, or vibration bonding. The fiber-reinforced resin member 3 is composed of fiber parts 5 and a resin part 6 The material of the fiber parts 5 is a fiber, for example, an aromatic polyamide fiber, a carbon fiber, or a glass fiber. The materials of the resin member 6 include, for example, resins such as polybutylene terephthalate, polyphenylene sulfide, polyamide, a liquid crystal polymer, polypropylene, and acrylonitrile-butadiene-styrene. For example, a prepreg in which the fiber parts 5 are impregnated with the resin part 6 in a half-cured state is stacked, and then is heat and a pressure are applied to the prepreg, so that the fiber-reinforced resin member 3 is produced.

As described above, the composite member 1 according to the present embodiment has the asperities 2b on the surface 2a of the aluminum member 2 that is in direct contact with the fiber-reinforced resin member 3, thereby producing the anchor effect. Furthermore, the aluminum hydroxide film 2d is formed on the surface 2a of the aluminum member 2. An oxygen atom of the hydroxyl group of the aluminum hydroxide film 2d and a hydrogen atom contained in resin form a hydrogen bond. Thus, a chemical bond is formed between the surface 2a of the aluminum member 2 and the fiber-reinforced resin member 3, thereby improving bonding strength. Furthermore, the surface 2a the aluminum member 2 on which the aluminum hydroxide film 2d is formed has pores of several tens to several hundreds nm, thereby enhancing the anchor effect. Hence, the composite member 1 has high bonding strength. If an impact is applied to the composite member 1, the fiber-reinforced resin member 3 is firmly bonded to the aluminum member 2, so that fiber parts 5 in the fiber-reinforced resin member 3 are broken before the fiber-reinforced resin member 3 peels off from the aluminum member 2. This absorbs the impact on the composite member 1. Hence, the composite member 1 in which the fiber-reinforced resin member 3 is bonded has higher impact absorption than a composite member in which a resin member not containing the fiber parts 5 is bonded. Such high impact absorption is provided in a part where the fiber-reinforced resin member 3 is bonded. Thus, a modification of the aluminum member 2 can be controlled according to the bonded part of the fiber-reinforced resin member 3.

[Method of Manufacturing the Composite Member]

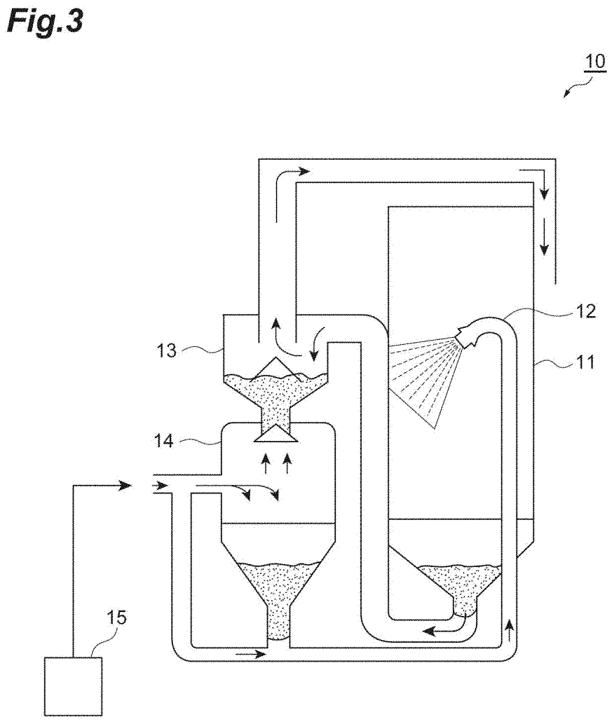

The outline of a machine used for the method of manufacturing the composite member 1 will be described below. The machine for blasting the surface of the aluminum member 2 will be first discussed below. The blasting machine may be any type of a gravity (suction) air-blast machine, a straight-hydraulic (pressure) air-blast machine, and a centrifugal blasting machine. In the manufacturing method according to the present embodiment, a so-called straight-hydraulic (pressure) air-blast machine is used as an example. FIG. 3 is a conceptual diagram illustrating a blasting machine 10 used for the method of manufacturing the composite member 1. The blasting machine 10 includes a blast chamber 11, a blast nozzle 12, a storage tank 13, a pressure chamber 14, a compressed-air feeder 15, and a dust collector (not illustrated).

The blast nozzle 12 is stored in the blast chamber 11 and blasting is performed on a workpiece (aluminum member 2) in the blast chamber 11. A blast material from the blast nozzle 12 falls with dust to the bottom of the blast chamber 11. The fallen blast material is fed into the storage tank 13 and the dust is fed into the dust collector. The blast material stored in the storage tank 13 is fed into the pressure chamber 14 and then the pressure chamber 14 is pressurized by the compressed-air feeder 15. The blast material stored in the pressure chamber 14 is fed with compressed air into the blast nozzle 12. In this way, the workpiece undergoes blasting while the blast material is circulated.

FIG. 4 is an explanatory drawing illustrating the configuration of the blasting machine 10 used for the method of manufacturing the composite member 1 according to the embodiment. The blasting machine 10 in FIG. 4 is the straight-hydraulic blasting machine illustrated in FIG. 3. In FIG. 4, the wall surface of the blast chamber 11 is partially omitted.

As illustrated in FIG. 4, the blasting machine 10 includes the blast-material storage tank 13 and the pressure chamber 14 that are connected to the compressed-air feeder 15 and have sealed structures, a fixed-quantity feeding part 16 communicating with the storage tank 13 in the pressure chamber 14, the blast nozzle 12 communicating with the fixed-quantity feeding part 16 via a connecting pipe 17, a work table 18 that can move while holding a workpiece below the blast nozzle 12, and a control unit 19.

The control unit 19 controls the constituent elements of the blasting machine 10. The control unit 19 includes, for example, a display unit and a processing unit. The processing unit is a typical computer including a CPU and a storage unit. The control unit 19 controls a feed rate from the compressed-air feeder 15 that feeds compressed air to the storage tank 13 and the pressure chamber 14 based on a set blast pressure and a set blast velocity. Moreover, the control unit 19 controls the position of a blast from the blast nozzle 12 based on a distance between the set workpiece and the nozzle and the workpiece scanning conditions (including a speed, a feed pitch, and the number of scans) of the workpiece. As a specific example, the control unit 19 controls the position of the blast nozzle 12 by using a scanning speed (X direction) and a feed pitch (Y direction) that are set before blasting. The control unit 19 controls the position of the blast nozzle 12 by moving the work table 18 holding the workpiece.

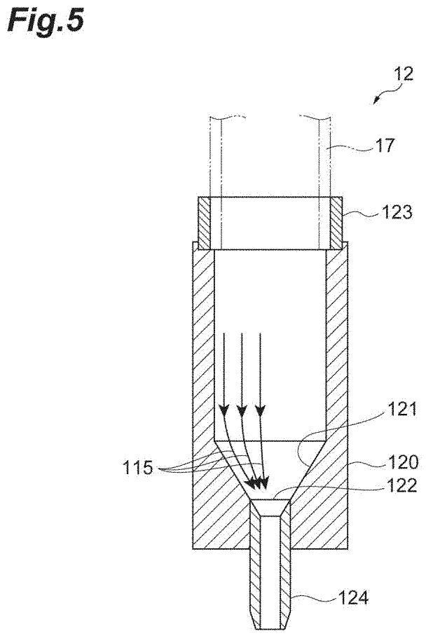

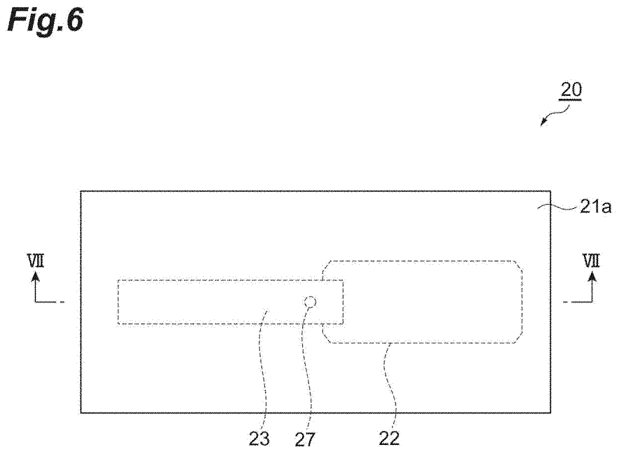

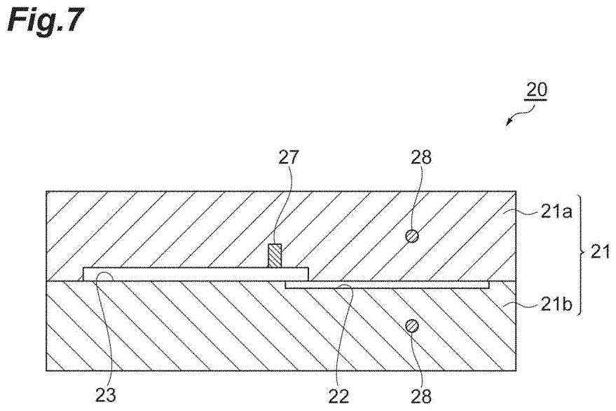

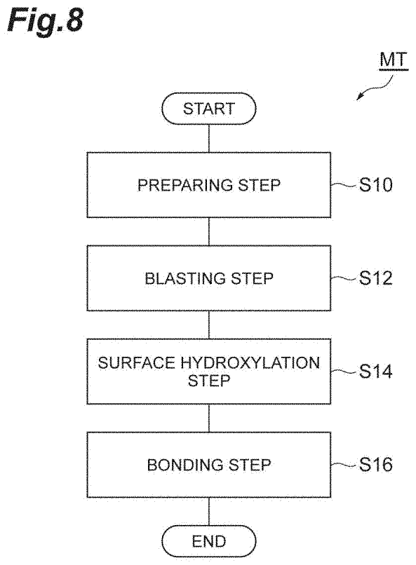

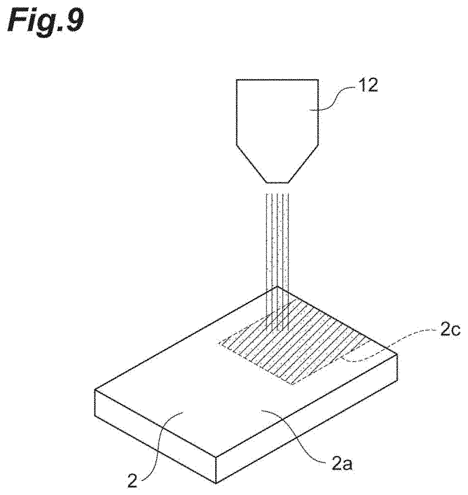

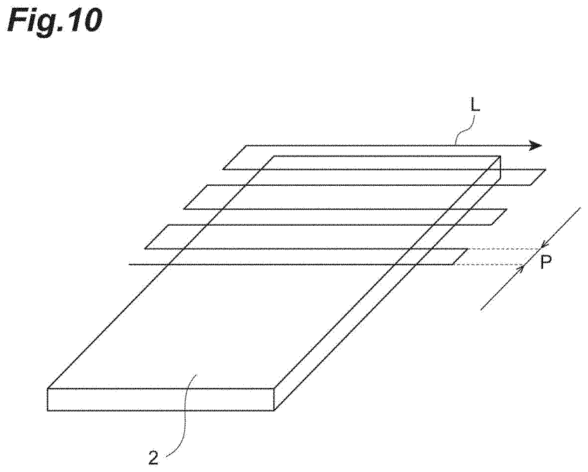

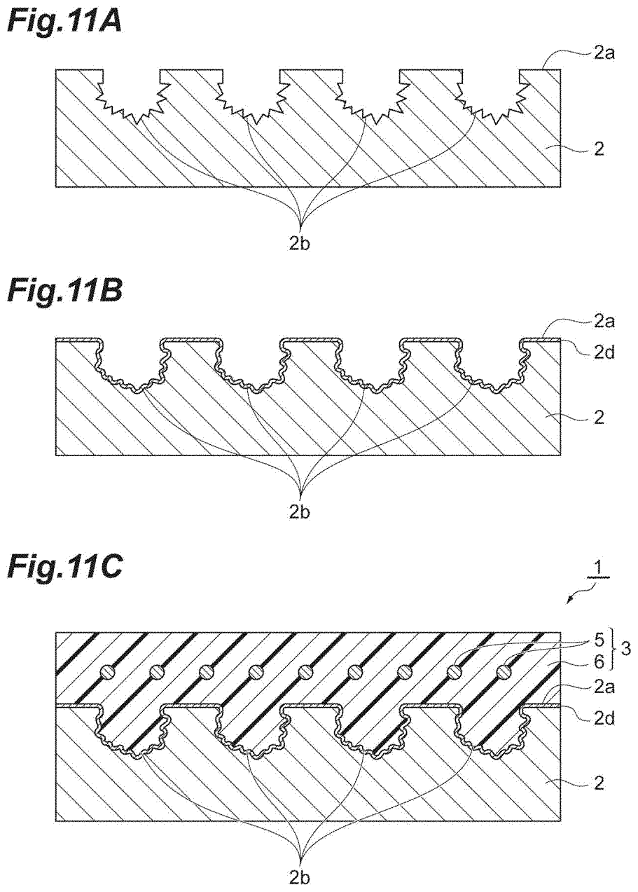

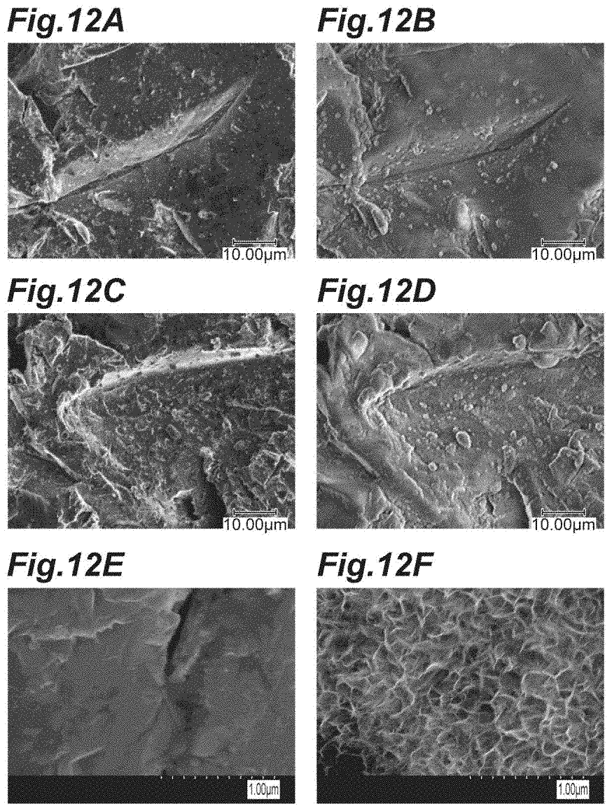

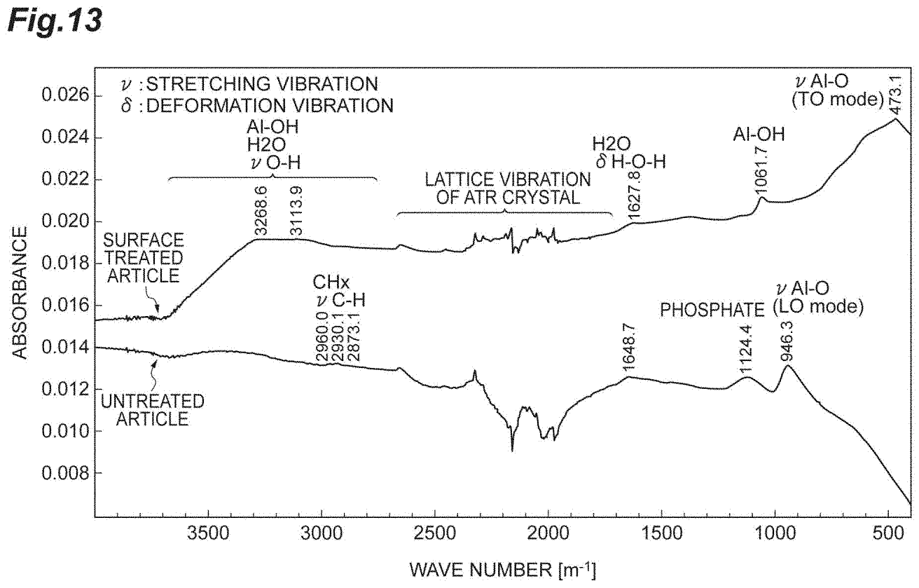

FIG. 5 is a cross-sectional view of the blast nozzle 12 illustrated in FIG. 4. The blast nozzle 12 has a blast-tube holder 120 serving as a body part. The blast-tube holder 120 is a cylindrical member having a space for passing the blast material and compressed air therein. One end of the blast-tube holder 120 is a blast-material inlet port 123 and the other end of the blast-tube holder 120 is a blast-material outlet port 122. The blast-tube holder 120 includes a convergence acceleration part 121 that is conical with an angle of tilt, the convergence acceleration part 121 having an inner wall surface tapering from the blast-material inlet port 123 toward the blast-material outlet port 122. A cylindrical blast tube 124 communicates with the blast-material outlet port 122 of the blast-tube holder 120. The convergence acceleration part 121 tapers from the midpoint of the cylindrical shape of the blast-tube holder 120 toward the blast tube 124. This forms a compressed airflow 115.

The connecting pipe 17 of the blasting machine 10 is connected to the blast-material inlet port 123 of the blast nozzle 12. This forms a blast material passage that sequentially connects the storage tank 13, the fixed-quantity feeding part 16 in the pressure chamber 14, the connecting pipe 17, and the blast nozzle 12.

In the blasting machine 10 configured thus, compressed air is fed from the compressed-air feeder 15 to the storage tank 13 and the pressure chamber 14 after the quantity of compressed air is controlled by the control unit 19. Subsequently, the blast material in the storage tank 13 is quantitatively determined by the fixed-quantity feeding part 16 in the pressure chamber 14 with a constant pressure flow force, the blast material is fed into the blast nozzle 12 through the connecting pipe 17, and then the blast material is directed from the blast tube of the blast nozzle 12 onto the work surface of the workpiece. Thus, a fixed quantity of the blast material is always directed onto the work surface of the workpiece. Subsequently, the position of a blast directed from the blast nozzle 12 onto the work surface of the workpiece is controlled by the control unit 19 and then the workpiece undergoes blasting.

The directed blast material and cut powder generated by blasting are sucked by the dust collector, which is not illustrated. On a passage from the blast chamber 11 to the dust collector, a classifier, which is not illustrated, is disposed to separate a reusable blast material and other fine powder (blast material not in a reusable size or cut powder generated by blasting). The reusable blast material is stored in the storage tank 13 and then is fed into the blast nozzle 12 again. The fine powder is collected by the dust collector.

Press forming will be described below. Press forming is a forming method in which metal and resin are placed in a predetermined mold, the mold is closed, and then heat and a pressure are applied to the mold for a predetermined time in such a way as to bond the mold and the resin. FIG. 6 is a cross-sectional view of the mold used for press forming FIG. 7 is a cross-sectional view of the mold taken along line VII-VII of FIG. 6. As illustrated in FIGS. 6 and 7, a mold 20 includes a mold body 21 (a cope 21a and a drag 21b). Between the cope 21a and the drag 21b, a space 22 for placing the aluminum member 2 and a space 23 for placing the fiber-reinforced resin member 3 are provided. A pressure sensor 27 and a temperature sensor 28 are provided in the space 23 and detect a pressure and a temperature in the space 23. Based on the detection results of the pressure sensor 27 and the temperature sensor 28, the parameters of a molding machine, which is not illustrated, are adjusted and then a molded article is manufactured. The parameters include a mold temperature, a press pressure, a retention time, a pressure during retention, a heat treatment temperature, and a heat treatment time. The article molded by the mold 20 has a lap joint structure that is joined with a predetermined structure.

The flow of the method of manufacturing the composite member 1 will be described below. FIG. 8 is a flowchart of a method MT of manufacturing the composite member 1 according to the embodiment. As depicted in FIG. 8, first, a predetermined blast material is charged into the blasting machine 10 as a preparing step (S10). The particle size of the blast material (abrasive grain) is, for example, 30 μm to 710 μm. The smaller the particle size of the blast material, the smaller mass of the blast material. This leads to a small inertial force. Thus, if the particle size of the blast material is smaller than 30 μm, it is difficult to form the asperities 2b in desired shapes. Moreover, the aluminum member 2 to be industrially used is typically stored in the atmosphere and the surface of the aluminum member 2 is covered with an uneven aluminum amorphous oxide film having a thickness of 60 nm to 300 nm. Hence, surface etching using a chemical agent and surface laser beam machining may cause uneven surface treatment because of the aluminum amorphous oxide film. In order to uniformly modify the surface of the aluminum member 2 in a surface hydroxylation step, which will be discussed later, the aluminum amorphous oxide film needs a thickness of about 30 nm or less. However, if the particle diameter of the blast material exceeds 710 μm, it is difficult to grind the aluminum amorphous oxide film to a thickness of about 30 nm or less. Hence, an aluminum oxide formed on the surface of the aluminum member 2 cannot be sufficiently removed. The asperities can be formed and the aluminum amorphous oxide film can be removed if abrasive grains have a particle size of 30 μm to 710 μm.

The control unit 19 of the blasting machine 10 acquires blasting conditions as the preparing step (S10). The control unit 19 acquires the blasting conditions based on an operation by an operator or information stored in the storage unit. The blasting conditions include a blast pressure, a blast velocity, a distance between nozzles, and workpiece scanning conditions (a speed, a feed pitch, and the number of scans). The blast pressure is, for example, 0.5 to 2.0 MPa. The lower the blast pressure, the smaller the inertial force. Thus, if the blast pressure is smaller than 0.5 MPa, it is difficult to form the asperities 2b in desired shapes. The higher the blast pressure, the larger the inertial force. Hence, the blast material is likely to be crushed by a collision with the aluminum member 2. This leads to the following problems: (1) poor working efficiency caused by the dispersion of collision energy in a process other than the formation of the asperities 2b and (2) high cost because the blast material considerably wears. Such problems become apparent when the blast pressure exceeds 2.0 MPa. The control unit 19 precisely performs micro-order or nano-order control on the size, depth, and density of the asperities 2b on the surface 2a of the aluminum member 2 by managing the blasting conditions. The blasting conditions may include a condition for specifying a blasting region. In this case, selective surface treatment is achieved.

Subsequently, the blasting machine 10 performs a series of processing as a blasting step (S12) as follows: First, the aluminum member 2 that is a target of blasting is set on the work table 18 in the blast chamber 11. The control unit 19 then activates the dust collector, which is not illustrated. The dust collector reduces a pressure in the blast chamber 11 to a negative pressure based on the control signal of the control unit 19. Thereafter, based on the control signal of the control unit 19, the blast nozzle 12 sends a blast of the blast material as a solid/gas two-phase flow of compressed air at a blast pressure of 0.5 to 2.0 MPa. The control unit 19 then activates the work table 18 and moves the aluminum member 2 into a blast flow of the solid/gas two-phase flow (below the blast nozzle in FIG. 4). FIG. 9 is a conceptual diagram of blasting. As illustrated in FIG. 9, the blast material is jetted from the blast nozzle 12 to a partial region 2c of the surface 2a of the aluminum member 2. At this point, the control unit 19 continuously activates the work table 18 such that a blast flow draws a predetermined path on the aluminum member 2. FIG. 10 is an explanatory drawing of a scan of blasting. As illustrated in FIG. 10, the control unit 19 operates the work table 18 according to a path L for scanning with the feed pitch P. This forms the micro-order or nano-order asperities 2b on the surface of the aluminum member 2 as desired.

By blasting using the blast material having a particle size of 30 to 710 μm at a blast pressure of 0.5 to 2.0 MPa, the micro-order or nano-order asperities 2b are formed on the surface 2a of the aluminum member 2 as desired (for example, the asperities 2b having an arithmetic mean inclination RΔa and a root-mean-square inclination RΔq that are controlled to 0.17 to 0.50 and 0.27 to 0.60, respectively). Furthermore, the amorphous oxide film on the surface of the aluminum member 2 has a thickness of about 9 nm or less. After the operation of the blasting machine 10 is stopped, the aluminum member 2 is removed and blasting is completed.

FIGS. 11A-11C are explanatory drawings of the manufacturing process of the composite member. As illustrated in FIG. 11A, the asperities 2b of the surface 2a of the aluminum member 2 have sharp projections after blasting.

Subsequently, as the surface hydroxylation step (S14), the surface 2a of the aluminum member 2 having undergone blasting is caused to react with water by using at least one of heat and plasma and the surface 2a of the aluminum member 2 is modified into aluminum hydroxide. In the surface hydroxylation step, the surface 2a of the aluminum member 2 is caused to react with water by using one of hydrothermal treatment, steam treatment, superheated steam treatment, liquid plasma, and atmospheric-pressure plasma containing water. An example of hydrothermal treatment will be described below. In hydrothermal treatment, the aluminum member 2 having undergone blasting is immersed in pure water, which is heated to at least 60° C., for a predetermined period. Thus, as illustrated in FIG. 11B, the asperities 2b are rounded. Furthermore, the surface 2a of the aluminum member 2 is mainly modified into aluminum hydroxide, forming the aluminum hydroxide film 2d. In hydrothermal treatment, the aluminum member 2 having undergone blasting is immersed in pure water, which is heated to at least 70° C., for a predetermined period. Thus, the surface 2a of the aluminum member 2 is mainly modified into boehmite, forming the aluminum hydroxide film 2d. The aluminum hydroxide film 2d may contain any one of diaspore, pseudo-boehmite, bayerite, nordstrandite, gibbsite, and doyleite as well as boehmite. The aluminum hydroxide film 2d may contain multiple kinds of aluminum hydroxides selected from the group consisting of diaspore, boehmite, pseudo-boehmite, bayerite, nordstrandite, gibbsite, and doyleite. A water temperature may be 60° C. or higher also in steam treatment, superheated steam treatment, liquid plasma, and atmospheric-pressure plasma containing water. The water temperature may be 300° C. or less in view of suppression of modification of aluminum.

In the surface hydroxylation step (S14), the surface of the aluminum member may be cleaned with water. If the surface hydroxylation step is performed in hydrothermal treatment, the surface of the aluminum member is cleaned with water, thereby reducing a surface carbon concentration. Hydrothermal treatment and ultrasonic cleaning may be combined to positively reduce the surface carbon concentration. For example, pure water is irradiated with ultrasonic waves while the aluminum member 2 is immersed in the pure water heated to at least 60° C. This can simultaneously perform hydrothermal treatment and surface washing.

Subsequently, the molding machine, which is not illustrated, performs press forming using the mold 20 as a bonding step (S16). The mold 20 is first opened, the aluminum member 2 with the surface modified to aluminum hydroxide is placed into the space 22, the fiber-reinforced resin member 3 is placed into the space 23, and then the mold 20 is closed. The molding machine controls a pressure to the set value during the set retention time based on the detection result of the pressure sensor 27. Moreover, the molding machine controls a mold temperature to a set value based on the detection result of the temperature sensor 28. Thereafter, the molding machine performs heat treatment based on a set pressure, a set heat-treatment temperature, and a set heat-treatment time. The molding machine then opens the mold 20 and removes the composite member 1 in which the aluminum member 2 and the fiber-reinforced resin member 3 have been integrated. At the end of the bonding step (S16), the flowchart in FIG. 8 is completed. The composite member 1 in FIG. 11C is manufactured thus.

As described above, according to the manufacturing method MT, blasting is performed on the surface 2a of the aluminum member 2. The asperities 2b having sharp projections are formed on the surface 2a of the aluminum member 2 having undergone blasting. Thereafter, the surface 2a of the aluminum member 2 is mainly modified into boehmite Thus, the sharp projections are rounded. The fiber-reinforced resin member 3 is directly bonded to the surface 2a of the aluminum member 2 modified to aluminum hydroxide. The fiber-reinforced resin member 3 is applied into the rounded asperities 2b and is cured therein. As described above, according to the manufacturing method MT, sharp projections that may break the fiber-reinforced resin member 3 can be removed by the surface hydroxylation step (S14), thereby improving the bonding strength of the composite member 1. Moreover, on the surface of the aluminum member 2, an oxygen atom of a hydroxyl group of boehmite and a hydrogen atom contained in the resin mainly form a hydrogen bond. Thus, a chemical bond is formed between the surface 2a of the aluminum member 2 and the fiber-reinforced resin member 3, thereby improving the bonding strength. Furthermore, the surface 2a the aluminum member 2 mainly composed of boehmite has pores of several tens to several hundreds nm. This can enhance the anchor effect. Moreover, an aluminum oxide film formed on the surface 2a of the aluminum member 2 is removed by blasting. An aluminum oxide film may interfere with the formation of the aluminum hydroxide film 2d. According to the manufacturing method MT, an aluminum oxide film is removed before aluminum hydroxide is formed, thereby uniformly modifying the surface 2a of the aluminum member 2 into aluminum hydroxide. If an impact is applied to the composite member 1, the fiber-reinforced resin member 3 is firmly bonded to the aluminum member 2, so that the fiber parts 5 in the fiber-reinforced resin member 3 are broken before the fiber-reinforced resin member 3 peels off from the aluminum member 2. This absorbs the impact on the composite member 1. Hence, the composite member 1 in which the fiber-reinforced resin member 3 is bonded has higher impact absorption than a composite member in which a resin member not containing the fiber parts 5 is bonded. Such high impact absorption is provided in a part where the fiber-reinforced resin member 3 is bonded. Thus, a modification of the aluminum member 2 can be controlled according to the bonded part of the fiber-reinforced resin member 3.

According to the manufacturing method MT, the aluminum hydroxide film 2d contains at least one of diaspore, boehmite, pseudo-boehmite, bayerite, nordstrandite, gibbsite, and doyleite. The aluminum hydroxide film 2d containing a combination of multiple kinds of aluminum hydroxides from among the foregoing aluminum hydroxides is formed such that water is heated at a lower temperature in the surface hydroxylation step (S14) than the aluminum hydroxide film 2d containing any one of the aluminum hydroxides.

According to the manufacturing method MT, the surface 2a of the aluminum member 2 is cleaned with water used for modification to aluminum hydroxide, thereby suppressing a reduction in bonding strength when the bonding strength is reduced by contamination with carbon. According to the manufacturing method MT, the particle size of abrasive grains used for the blasting step is 30 μm to 710 μm, so that an oxide film formed on the surface 2a of the aluminum member 2 can be properly removed. This can form a uniform aluminum hydroxide film 2d on the surface 2a of the aluminum member 2.

According to the manufacturing method MT of the present embodiment, the aluminum member 2 and the fiber-reinforced resin member 3 are fixed by the mold 20 in the press forming of the bonding step (S16), so that the accuracy of dimension of the bonded composite member 1 can be higher than in other bonding methods.

The foregoing embodiment does not limit the present disclosure. As a matter of course, the present disclosure can be modified in various ways without departing from the scope of the disclosure.

[Modification of the Base Material and the Fiber-Reinforced Resin Member]

The aluminum member 2 and the fiber-reinforced resin member 3 were described as plate members in the embodiment. The shapes are not limited and any shapes can be used as long as the members can be brought into contact with each other. The fiber-reinforced resin member 3 according to the embodiment is in contact with a part of the surface of the aluminum member 2. The fiber-reinforced resin member 3 may be brought into contact with the overall surface of the aluminum member 2.

[Modification of Bonding]

The aluminum member 2 and the fiber-reinforced resin member 3 may be bonded by ultrasonic bonding. In the ultrasonic bonding, the molding machine may generate ultrasonic vibrations on at least one of the aluminum member 2 and the fiber-reinforced resin member 3 in such a way as to bond the aluminum member 2 and the fiber-reinforced resin member 3. In the ultrasonic bonding, only the bonded part between the aluminum member 2 and the fiber-reinforced resin member 3 is heated, thereby preventing the composite member 1 from warping after the bonding due to a difference in the coefficient of thermal expansion between the aluminum member 2 and the fiber-reinforced resin member 3.

### EXAMPLE

[Grain Size of the Blast Material]

First, the thickness of the oxide film of the aluminum member 2 was measured before the blasting step (S12) was performed. The aluminum oxide film was analyzed in the depth direction by using Auger electron spectroscopy (AES). An oxide and a metal component were simultaneously detected around an oxide/metal interface and thus were separated by a spectral synthesis method, so that the thickness of the oxide film was determined. The oxide film was 72 nm in thickness. Subsequently, the blasting step (S12) was performed using the blasting machine illustrated in FIGS. 3 to 5 and then the thickness of the oxide film of the aluminum member 2 was measured. In the case of a blast material in which abrasive grains had a center particle size of 600 μm to 710 μm, an oxide film was 13 nm in thickness. In the case of a blast material in which abrasive grains had a center particle size of 41 μm to 50 μm (a maximum particle size of 127 μm or less and a mean particle size of 57 μm±3 μm), an oxide film was 9 nm in thickness. Thus, it was confirmed that the oxide film of the surface 2a of the aluminum member 2 can be removed by using the blast material of at least 710 μm.

[Confirmation of Surface State of the Aluminum Member]

The blasting step (S12) was performed by using the blasting machine illustrated in FIGS. 3 to 5. An aluminum plate (Japanese Industrial Standards (JIS): A5052) was used as the aluminum member. The blast material containing alumina with an abrasive-grain center particle size of 106 μm to 125 μm was used for blasting. The blast pressure was 1.0 MPa. After the blasting step, the surface was observed using a field emission scanning electron microscope (FE-SEM).

Subsequently, the surface hydroxylation step (S14) was performed. The aluminum plate having undergone blasting was immersed in pure water at 90° C. for five minutes. The surface was then observed by using the field emission scanning electron microscope (FE-SEM).

FIGS. 12A-12F indicate the surface observation results of the aluminum member. FIG. 12A indicates the surface observation result of the aluminum plate after the blasting step (S12). FIG. 12B indicates the surface observation result of the aluminum plate after the surface hydroxylation step (S14). Similarly, FIGS. 12C and 12E indicate the surface observation results of the aluminum plate after the blasting step (S12). FIGS. 12D and 12F indicate the surface observation results of the aluminum plate after the surface hydroxylation step (S14).

As indicated in FIGS. 12A and 12C, it was confirmed that the surface 2a of the aluminum member 2 had asperities and sharp projections after the blasting step (S12). In contrast, as indicated in FIGS. 12B and 12D, it was confirmed that the surface 2a of the aluminum member 2 was entirely rounded after the surface hydroxylation step (S14). As is evident from a comparison between FIGS. 12E and 12F, it was confirmed that the surface of the aluminum plate had pores of several tens to several hundreds nm after the surface hydroxylation step (S14).

[Confirmation of Surface Composition of the Aluminum Member]

### Example: Surface Treated Article

The blasting step (S12) was performed by using the blasting machine illustrated in FIGS. 3 to 5. An aluminum plate (JIS: A5052) was used as an aluminum member. The blast material containing alumina with an abrasive-grain center particle size of 106 μm to 125 μm was used for blasting. The blast pressure was 1.0 MPa. Subsequently, the surface hydroxylation step (S14) was performed. The aluminum plate having undergone blasting was immersed in pure water at 90° C. for five minutes.

### Comparative Example: Untreated Article

The blasting step (S12) and the surface hydroxylation step (S14) were not performed on an aluminum plate (JIS: A5052).

The surface compositions of the surface treated article and the untreated article were analyzed using Fourier transform infrared spectroscopy (FT-IR) according to attenuated total reflectance (ATR). The analysis results are indicated in FIG. 13.

FIG. 13 indicates the analysis results of the surface compositions of the aluminum members. In the graph of FIG. 13, the abscissa indicates a wave number and the ordinate indicates an absorbance. Waveform data in the upper part of the graph indicates the composition analysis result of the surface treated article, whereas waveform data in the lower part of the graph indicates the composition analysis result of the untreated article. As is evident from FIG. 13, the waveform data of the untreated article reached peaks at wave numbers of 3960 m⁻¹, 3930 m⁻¹, and 2873 m⁻¹ because of contamination with carbon (e.g., C—H) and a peak (Al—O) at a wave number of 946 m⁻¹ because of an aluminum oxide. Any peak caused by boehmite was not confirmed. In the data of the surface treated article, a peak caused by contamination with carbon (e.g., C—H) before treatment and a peak caused by an aluminum oxide (Al—O) disappeared and peaks caused by boehmite appeared at wave numbers of 3268 m⁻¹ and 3113 m⁻¹. Hence, it was confirmed that an oxide and contamination with carbon on the surface of the aluminum member 2 were removed by surface treatment and aluminum hydroxide was formed.

[Confirmation of a Surface Carbon Concentration]

The surface carbon concentration of the aluminum member 2 having undergone the surface hydroxylation step (S14) and the surface carbon concentration of the untreated article were measured and compared with each other. For the measurement, X-ray photoelectron spectroscopy (XPS) was used. Consequently, the surface carbon concentration of the untreated article was 40 at %, whereas the aluminum member 2 having undergone the surface hydroxylation step (S14) had a surface carbon concentration of 8 at %. Thus, a cleaning effect was confirmed as a secondary effect of hydrothermal treatment.

[Confirmation of Shearing Strength]

Example 1 and comparative examples 1 to 4 were prepared to confirm shearing strength.

### Example 1

The blasting step (S12) was performed by using the blasting machine illustrated in FIGS. 3 to 5. An aluminum plate (JIS: A5052) was used as an aluminum member. The blast material containing alumina with an abrasive-grain center particle size of 106 μm to 125 μm was used for blasting. The blast pressure was 1.0 MPa. Subsequently, the surface hydroxylation step (S14) was performed. The aluminum plate having undergone blasting was immersed in pure water at 90° C. for five minutes. Thereafter, the bonding step (S16) was performed. The fiber-reinforced resin member 3 was bonded to the aluminum member 2 by using the mold 20 illustrated in FIGS. 6 and 7. CFRTP was used for the fiber-reinforced resin member 3. The fiber-reinforced resin member 3 was set to have dimensions: 10 mm (L) 45 mm (W) 3.0 mm (T). During the retention time of the press forming (the closing of the mold), the mold temperature was set at 220° C., the retention pressure was set at 5 MPa and the retention time was set at 300 s. An overlap of 5 mm was made between the aluminum member 2 and the fiber-reinforced resin member 3.

### Comparative Examples 1 to 4

In comparative example 1, an aluminum plate (JIS: A5052) having not undergone the blasting step (S12) and the surface hydroxylation step (S14) was used as an aluminum member. Comparative example 1 is a member in which the aluminum member and the CFRTP are bonded to each other.

In comparative example 2, an aluminum plate (JIS: A5052) having not undergone the blasting step (S12) and the surface hydroxylation step (S14) was used as an aluminum member. Comparative example 2 is a member in which the aluminum member and the CFRTP are bonded to each other with adhesive. A second-generation acrylic adhesive (SGA) was used as the adhesive.

In comparative example 3, an aluminum plate (JIS: A5052) having undergone the surface hydroxylation step (S14) as in example 1 was used as an aluminum member without undergoing the blasting step (S12). The bonding step (S16) was performed as in example 1.

In comparative example 4, an aluminum plate (JIS: A5052) having undergone the blasting step (S12) as in the example was used as an aluminum member without undergoing the surface hydroxylation step (S14). The bonding step (S16) was performed as in the example.

[Evaluation of Bonding Strength]

The shearing strengths of example 1 and comparative examples 1 to 4 prepared under the foregoing conditions were measured. An evaluation apparatus conducted measurements according to a testing method in conformity with ISO19095. The shearing strength of comparative example 1 was 0 MPa, the shearing strength of comparative example 2 was 10 MPa, the shearing strength of comparative example 3 was 1 MPa, the shearing strength of comparative example 4 was 10 MPa, and the shearing strength of example 1 was 20 MPa.

By comparing comparative example 1 and comparative example 3, it was confirmed that the shearing strength was not so remarkably improved only by the surface hydroxylation step (S14). By comparing comparative example 1 and comparative example 4, it was confirmed that the shearing strength was improved by the blasting step (S12). By comparing the example 1 and comparative examples 1, 3, and 4, it was confirmed that the shearing strength was remarkably improved by a combination of the blasting step (S12) and the surface hydroxylation step (S14). By comparing example 1 and comparative example 2, it was confirmed that the shearing strength was remarkably improved by a combination of the blasting step (S12) and the surface hydroxylation step (S14) compared to the bonding with the adhesive. Furthermore, it was confirmed that the bonding method of example 1 is completed in a shorter time than the bonding with the adhesive in comparative example 2.

[Confirmation of Impact Absorption]

Example 2 and comparative example 5 were prepared to confirm impact absorption.

### Example 2

CFRTP was bonded as a fiber-reinforced resin member to a part of an aluminum member. A hat-shaped aluminum structure was used as the aluminum member. The hat-shaped aluminum structure was formed by an aluminum plate (JIS: A5052) and the top of the structure was set to have dimensions: 33 mm (W) 300 mm (D) 32 mm (H). The width of the bottom of the hat-shaped aluminum structure was set at 65 mm. The blasting step (S12) was performed on a part to which the CFRTP is bonded in the hat-shaped aluminum structure, by using the blasting machine illustrated in FIGS. 3 to 5. The blast material containing alumina with an abrasive-grain center particle size of 106 μm to 125 μm was used for blasting. The blast pressure was 1.0 MPa. Subsequently, the surface hydroxylation step (S14) was performed. The hat-shaped aluminum structure having undergone blasting was immersed in pure water at 90° C. for five minutes. Thereafter, the bonding step (S16) was performed. The CFRTP was bonded to the hat-shaped aluminum structure by using the mold 20 illustrated in FIGS. 6 and 7 while a pad is placed on the hat-shaped aluminum structure by a jig, forming the composite member. During press forming, the mold temperature was set at 220° C., the retention pressure was set at 5 MPa and the retention time was set at 300 s. The area ratio of the CFRTP to the total surface area including the inner wall of the hat-shaped aluminum structure was about 5.1%. The weight ratio of the CFRTP to the hat-shaped aluminum structure was about 6.7%.

### Comparative Example 5

In comparative example 5, a hat-shaped aluminum structure formed with an aluminum plate (JIS: A5052) having not undergone the blasting step (S12) and the surface hydroxylation step (S14) was used as an aluminum member. Comparative example 5 is a member in which the hat-shaped aluminum structure and the CFRTP are bonded to each other with adhesive. A second-generation acrylic adhesive (SGA) was used as the adhesive. Other conditions are identical to those of example 2.

[Evaluation of Impact Absorption]

As the impact absorption of example 2 and comparative example 5 that are prepared under the foregoing conditions, an impact load capacity and impact absorbing energy were measured by using a drop-weight impact tester. The drop-weight impact tester includes a three-point bending jig supporting the composite member, a drop hammer for applying an impact to the composite member, and a guide post for guiding the drop hammer. The three-point bending jig has a pair of fulcrums supporting the composite member. The pair of fulcrums supports both ends of the composite member of example 2 and the composite member of comparative example 5 in the depth direction. A length between the paired fulcrums of the three-point bending jig is 240 mm. The weight of the drop hammer is 13.10 kg. The drop hammer falls along a guide post to the center of the composite member in the depth direction while the composite member is supported by the three-point bending jig. The velocity of the drop hammer hitting the composite member is 10 m/s.

The impact load capacity of the composite member of example 2 is about 20% larger than that of the composite member of comparative example 5. The impact absorbing energy of the composite member of example 2 is about 10% larger than that of the composite member of comparative example 5. By comparing example 2 and comparative example 5, it was confirmed that the impact load capacity and the impact absorbing energy were remarkably improved by a combination of the blasting step (S12) and the surface hydroxylation step (S14) as compared with bonding with adhesive.

### REFERENCE SIGNS LIST

1 . . . composite member, 2 . . . aluminum member, 3 . . . fiber-reinforced resin member, 10 . . . blasting machine, 11 . . . blast chamber, 12 . . . blast nozzle, 13 . . . storage tank, 14 . . . pressure chamber, 15 . . . compressed-air feeder, 16 . . . fixed-quantity feeding part, 17 . . . connecting pipe, 18 . . . work table, 19 . . . control unit, 20 . . . mold, 21 . . . mold body

What is claimed is:

1. A method of manufacturing a composite member including an aluminum member and a fiber-reinforced resin member bonded to each other, the method comprising:
performing blasting on a surface of the aluminum member;
modifying the surface of the aluminum member into aluminum hydroxide, the modifying including causing the surface of the aluminum member having undergone blasting to react with water by using at least one of heat and plasma; and
directly bonding the fiber-reinforced resin member to the surface of the aluminum member modified to the aluminum hydroxide.

2. The method according to claim 1, wherein the aluminum hydroxide contains at least one of diaspore, boehmite, pseudo-boehmite, bayerite, nordstrandite, gibbsite, and doyleite.

3. The method according to claim 1, wherein the modifying includes cleaning the surface of the aluminum member with the water and modifying the surface of the aluminum member to the aluminum hydroxide.

4. The method according to claim 2, wherein the modifying includes cleaning the surface of the aluminum member with the water and modifying the surface of the aluminum member to the aluminum hydroxide.

5. The method according to claim 1, wherein the modifying includes causing the surface of the aluminum member to react with water by using one of hydrothermal treatment, steam treatment, superheated steam treatment, liquid plasma, and atmospheric-pressure plasma containing water.

6. The method according to claim 2, wherein the modifying includes causing the surface of the aluminum member to react with water by using one of hydrothermal treatment, steam treatment, superheated steam treatment, liquid plasma, and atmospheric-pressure plasma containing water.

7. The method according to claim 3, wherein the modifying includes causing the surface of the aluminum member to react with water by using one of hydrothermal treatment, steam treatment, superheated steam treatment, liquid plasma, and atmospheric-pressure plasma containing water.

8. The method according to claim 4, wherein the modifying includes causing the surface of the aluminum member to react with water by using one of hydrothermal treatment, steam treatment, superheated steam treatment, liquid plasma, and atmospheric-pressure plasma containing water.

9. The method according to claim 1, wherein abrasive grains used in the blasting have a particle size of 30 μm to 710 μm.

10. The method according to claim 2, wherein abrasive grains used in the blasting have a particle size of 30 μm to 710 μm.

11. The method according to claim 3, wherein abrasive grains used in the blasting have a particle size of 30 μm to 710 μm.

12. The method according to claim 4, wherein abrasive grains used in the blasting have a particle size of 30 μm to 710 μm.

13. The method according to claim 5, wherein abrasive grains used in the blasting have a particle size of 30 μm to 710 μm.

14. The method according to claim 1, wherein the bonding includes directly bonding the fiber-reinforced resin member to the surface of the aluminum member by press forming or ultrasonic bonding.

15. The method according to claim 2, wherein the bonding includes directly bonding the fiber-reinforced resin member to the surface of the aluminum member by press forming or ultrasonic bonding.

16. The method according to claim 3, wherein the bonding includes directly bonding the fiber-reinforced resin member to the surface of the aluminum member by press forming or ultrasonic bonding.

17. The method according to claim 4, wherein the bonding includes directly bonding the fiber-reinforced resin member to the surface of the aluminum member by press forming or ultrasonic bonding.

18. The method according to claim 5, wherein the bonding includes directly bonding the fiber-reinforced resin member to the surface of the aluminum member by press forming or ultrasonic bonding.

19. A composite member comprising:
an aluminum member having asperities on a surface of the aluminum member and an aluminum hydroxide film formed on the surface of the aluminum member; and
a fiber-reinforced resin member in direct contact with the surface of the aluminum member on which the aluminum hydroxide film is formed.

20. The composite member according to claim 19, wherein the aluminum hydroxide film contains at least one of diaspore, boehmite, pseudo-boehmite, bayerite, nordstrandite, gibbsite, and doyleite.
